(19) United States
(12) Patent Application Publication
(10) Pub. No.: US 2011/0286818 A1
(43) Pub. Date: Nov. 24, 2011

(54) SUBSTRATE PROCESSING APPARATUS AND METHOD

(75) Inventors: Ul Tae Kim, Suwon-si (KR); Sang Hyun Park, Yongin-si (KR); Hi Kuk Lee, Yongin-si (KR); Sang Don Jang, Suwon-si (KR)

(73) Assignee: SAMSUNG ELECTRONICS CO., LTD., Suwon-si (KR)

(21) Appl. No.: 13/110,435

(22) Filed: May 18, 2011

(30) Foreign Application Priority Data
May 19, 2010 (KR) 10-2010-0046941

(51) Int. Cl. B65G 49/05

(52) U.S. Cl. 414/222.01; 414/806

(57) ABSTRACT

According to an example embodiment a substrate processing apparatus includes a supporting unit, a lifting unit on at least a side of the supporting unit, a tray supported by the lifting unit, and a transfer unit configured to transfer a substrate to the tray such that the substrate is positioned on the tray. The lifting unit moves the tray up and down to load or unload the substrate located on the tray on or from the supporting unit.

### CROSS-REFERENCE TO RELATED APPLICATION

This application claims priority under 35 U.S.C. §119 to Korean Patent Application No. 2010-0046941, filed on May 19, 2010 in the Korean Intellectual Property Office, the entire disclosure of which is incorporated herein by reference.

### BACKGROUND

1. Field

Example embodiments relate to an apparatus and method of loading and unloading a substrate on or from a supporting unit during a substrate processing operation.

2. Description of the Related Art

Generally, a thin film deposition process to deposit a thin-film dielectric material on a substrate, a photolithography process to expose or cover a selected portion of the thin film using a photosensitive material, an etching process to remove the selected portion of the thin film to pattern the thin film, and a cleaning process to remove residue are repeated several times during manufacture of a liquid crystal display.

During such a substrate processing operation, a supporting unit, such as a susceptor or a chuck to position and support the substrate, and various transferring units to transfer the substrate to the supporting unit such that the substrate is loaded on or unloaded from the supporting unit are used.

As the size of the substrate has greatly increased with the development of technology in recent years, a possibility of the large substrate being damaged is increased during transfer and positioning of the substrate on the supporting unit. Consequently, a transfer apparatus to stably load and/or unload the substrate on and/or from the supporting unit without damage to the substrate is proposed.

### SUMMARY

According to an example embodiment, a substrate processing apparatus includes a supporting unit, a lifting unit on at least a side of the supporting unit, a tray supported by the lifting unit, and a transfer unit configured to transfer a substrate to the tray such that the substrate is positioned on the tray. The lifting unit is configured to move the tray up and down to load or unload the substrate positioned on the tray.

According to an example embodiment, the lifting unit comprises support parts configured to support the tray and vertical transfer parts configured to move the tray and the substrate up and down.

According to an example embodiment, each support part includes a plurality of support grooves configured to supportingly engage the tray.

According to an example embodiment, the tray comprises a plurality of frames, and the frames form lattices.

According to an example embodiment, each frame comprises avoidance grooves configured to avoid interference between the plurality of frames and a transfer part of the transfer unit.

According to an example embodiment, each frame further comprises incline parts configured to position the substrate.

According to an example embodiment, the supporting unit includes through grooves at positions corresponding to the frames. The tray is lowered into the supporting unit via the through grooves.

According to an example embodiment, the supporting unit includes a plurality of sub-supporting units, and the plurality of sub-supporting units include through channels therebetween at positions corresponding to the frames. The tray is lowered into the supporting unit via the through channels.

According to an example embodiment, a substrate transferring method includes disposing a tray supported by a lifting unit, positioning a substrate on the tray using a transferring unit, and moving the tray up and down using the lifting unit to load or unload the substrate positioned on the tray. The lifting unit is on at least a side of a supporting unit,

According to an example embodiment, moving the tray up and down using the lifting unit includes supporting the tray using support parts of the lifting unit, and moving the tray and the substrate up and down using vertical transfer parts of the lifting unit.

According to an example embodiment, the substrate transferring method further includes providing each support part with support grooves configured to supportingly engage the tray.

According to an example embodiment, the substrate transferring method further includes providing the tray including a plurality of frames, and the plurality of frames form lattices.

According to an example embodiment, the substrate transferring method further includes providing avoidance grooves configured to avoid interference between the frames and a transfer part of the transfer unit on each frame.

According to an example embodiment, the substrate transferring method further includes providing each frame with incline parts configured to position the substrate.

According to an example embodiment, the substrate transferring method further includes providing the supporting unit with through grooves at positions corresponding to the frames, and lowering the tray into the supporting unit via the through grooves.

According to an example embodiment, the substrate transferring method further includes providing the supporting unit with a plurality of sub-supporting units, the plurality of sub-supporting units including through channels therebetween at positions corresponding to the frames, and lowering the tray into the supporting unit via the through channels.

According to an example embodiment, moving the tray includes moving the support parts and the tray supported by the support parts downward, the tray being moved along the through grooves of the supporting unit, and separating the substrate from the tray and simultaneously loading the substrate on the supporting unit.

According to an example embodiment, moving the tray includes moving the support parts and the tray supported by the support parts upward, the tray being moved along the through grooves of the supporting unit, and positioning the substrate on the tray and simultaneously unloading the substrate from the support.

According to an example embodiment, moving the tray includes moving the support parts and the tray supported by the support parts downward, the tray being moved along the through channels, and separating the substrate positioned on the tray and simultaneously loading the substrate on the supporting unit.

According to an example embodiment, moving the tray includes moving the support parts and the tray supported by the support parts upward, the tray being moved along the through channels, and positioning the substrate on the tray and simultaneously unloading the substrate from the support.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a perspective view illustrating a substrate processing apparatus according to an example embodiment;

FIG. 2 is an exploded perspective view illustrating a coupling relationship between a lifting unit and a tray of the substrate processing apparatus of FIG. 1;

FIG. 3 is a perspective view illustrating another example of the tray;

FIG. 4 is a perspective view illustrating another example of the lifting unit;

FIG. 5 is a perspective view illustrating another example of a supporting unit;

FIG. 6 is a perspective view illustrating a state in which a substrate is transferred to the tray by a transfer part of a transfer unit;

FIG. 7 is a perspective view illustrating a state in which the substrate is positioned on the tray; and

FIG. 8 is a perspective view illustrating a state in which the lifting unit and the tray are moved downward to position the substrate on the supporting unit.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

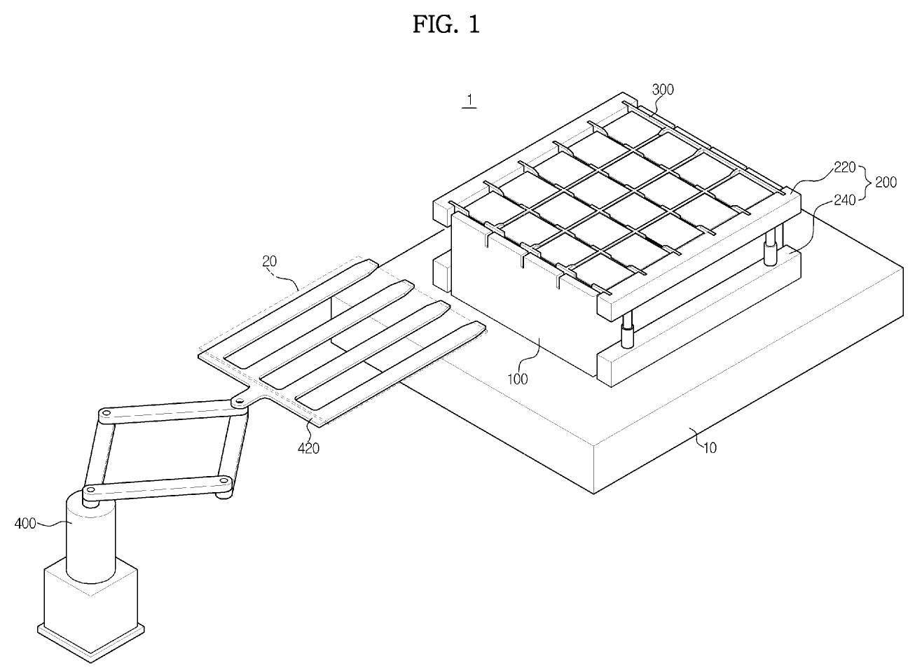

FIG. 1 is a perspective view illustrating a substrate processing apparatus according to an example embodiment.

As shown in FIG. 1, the substrate processing apparatus 1 includes a bottom plate 10, a supporting unit 100 disposed on the bottom plate 10, a lifting unit 200 disposed around the supporting unit 100, a tray 300 supported by the lifting unit 200, and a transfer unit 400 to transfer a substrate 20 to the tray 300 such that the substrate 20 is positioned on the tray 300.

The transfer unit 400 includes a transfer part 420. The transfer part 420 positions the substrate 20 on the tray 300 in a vacuum suction state.

The transfer unit 400 may be generally implemented by a substrate transfer robot. However, the transfer unit 400 is not particularly restricted as long as the transfer unit 400 includes a drive part and transfer part to position the substrate 20 on the tray 300.

In the drawing, the supporting unit 100 and the tray 300 are shown in a quadrangular shape, which corresponds to the shape of a substrate generally used in liquid crystal displays (LCDs). Therefore, the shape of the supporting unit 100 and the tray 300 may be changed if the shape of the substrate is changed.

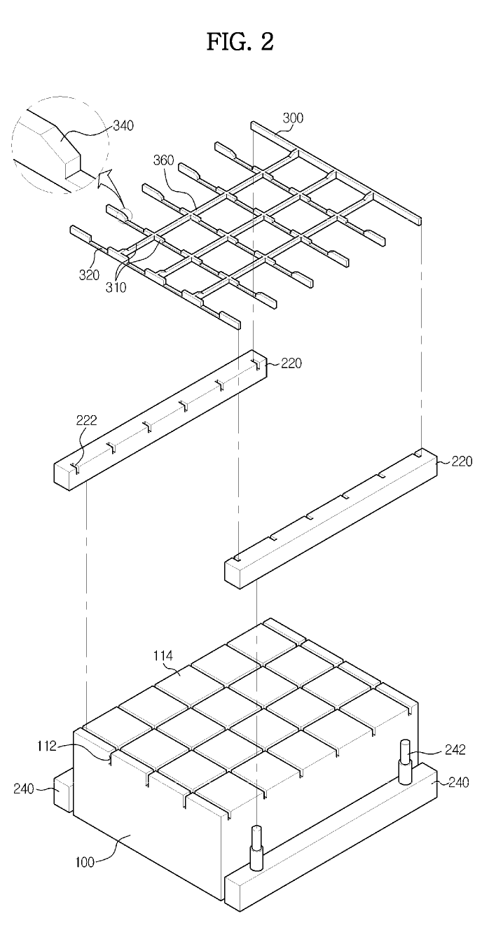

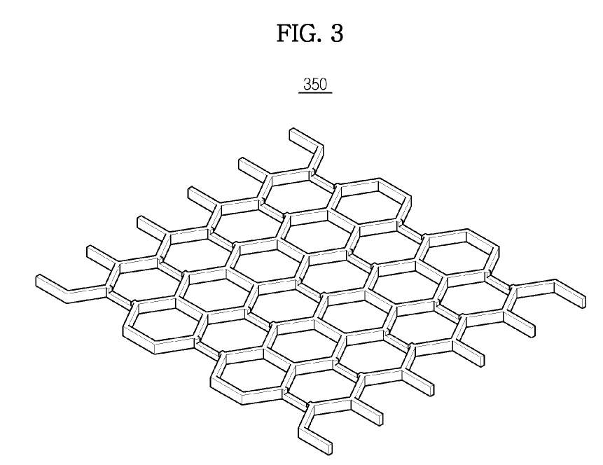

FIG. 2 is an exploded perspective view illustrating a coupling relationship between a lifting unit and a tray of the substrate processing apparatus of FIG. 1, and FIG. 3 is a perspective view illustrating another example of the tray.

As shown in FIG. 2, the supporting unit 100 is configured approximately in the shape of a rectangular parallelepiped. The supporting unit 100 is provided at the top thereof with a substrate location surface 114 on which the substrate 20 is positioned. The supporting unit 100 is also provided at the upper part thereof with through grooves 112 through which the tray 300 is inserted into the supporting unit 100.

The substrate location surface 114 is provided at the top of the supporting unit 100. When the substrate 20 is positioned on the substrate location surface 114, the substrate location surface 114 is brought into tight contact with the substrate 20 by a suction unit (not shown) included in the supporting unit 100. Consequently, the movement of the substrate is prevented during a substrate processing operation.

The through grooves 112 are arranged in a shape corresponding to the shape of a lattice structure constituted by a plurality of frames 310 included in the tray 300. Also, the through grooves 112 are formed at positions corresponding to the frames 310. The through grooves 112 have a width slightly greater than that of the frames 310 to prevent occurrence of interference between the through grooves 112 and the frames 310.

Also, the through grooves 112 have a depth slightly greater than the height of the frames 310 such that the tray 300 is inserted into the supporting unit 100, and therefore, the substrate 20 is positioned on the substrate location surface 114 with relative ease.

For example, the supporting unit 100 may be implemented by a susceptor or a chuck.

The lifting unit 200 is disposed around the supporting unit 100. The lifting unit 200 includes support parts 220 and vertical transfer parts 240.

Each of the support parts 220 has support grooves 222 in which the frames 310 of the tray 300 are coupled.

The vertical transfer parts 240 transfer the support parts 220 upward and downward. Each of the vertical transfer parts 240 may include transfer cylinders 242.

The vertical transfer parts 240 are connected to the respective support parts 220 via the transfer cylinders 242. The vertical transfer parts 240 serve to simultaneously transfer the support parts 220 and the tray 300, on which the substrate is positioned, upward and downward.

In an example embodiment, the transfer devices of the lifting unit 200 are implemented by the transfer cylinders 242. However, the transfer devices of the lifting unit 200 are not particularly restricted as long as the transfer devices transfer an object upward and downward. For example, the transfer devices of the lifting unit 200 may be implemented by ball screws and linear guides.

The lifting unit 200 to position the substrate 20 on the supporting unit 100 is disposed around the supporting unit 100. Consequently, a substrate transfer structure may not be mounted in an internal space or a lower space of the supporting unit 100.

The tray 300 includes a plurality of frames 310.

As shown in FIG. 2, the frames 310 are arranged at right angles to one another to form quadrangular lattices.

For a large substrate, the center of the substrate may droop since the substrate is thin. The lattices stably support the substrate, thereby preventing the substrate from drooping.

The number of the lattices may be changed based on kind and size of the substrate 20 such that the substrate 20 is stably supported by the lattices.

That is, as shown in FIG. 3, a tray 350 may be configured in a honeycomb type lattice structure including approximately hexagonal lattices.

The frames 310 are provided with avoidance grooves 320 to prevent interference between the frames 310 and the transfer part 420 of the transfer unit 400.

The substrate 20 is transferred on the tray 300 by the transfer part 420 of the transfer unit 400. The transfer part 420 has a predetermined/desired thickness, with the result that the transfer part 420 may come in contact with the frames 310 while the substrate 20 is positioned on the tray 300.

The avoidance grooves 320 have a size slightly greater than the width and thickness of the transfer part 420 so as to constitute spaces in which the transfer part 420 is placed between the frames 310.

Each of the frames 310 is provided at opposite ends thereof with incline parts 340 by which the substrate 20 is automatically aligned on the tray 300.

When the substrate 20 is transferred on the tray 300 by the transfer part 420, the substrate 20 may be incorrectly positioned on substrate support surfaces 360 of the tray 300. When the substrate is placed on the incline parts 340, the substrate 20 moves along inclines of the incline parts 340 and thus is positioned on the substrate support surfaces 360 of the tray 300.

The substrate support surfaces 360, which are in direct contact with the substrate 20 to support the substrate 20, are provided at the respective frames 310.

While the substrate 20 is positioned on the supporting unit 100, the substrate 20 is supported by the substrate support surfaces 360, thereby preventing the substrate 20 from bending or stress from concentrating on the surface of the substrate 20.

Various operations are performed while the substrate 20 is positioned on the tray 300. The tray 300 may be made of aluminum or anodized aluminum to exhibit high corrosion and acid resistance.

Anodizing is a method of specially treating the surface of aluminum to improve strength, acid resistance and/or wear resistance of aluminum, which is well-known, and therefore, a description thereof will be omitted.

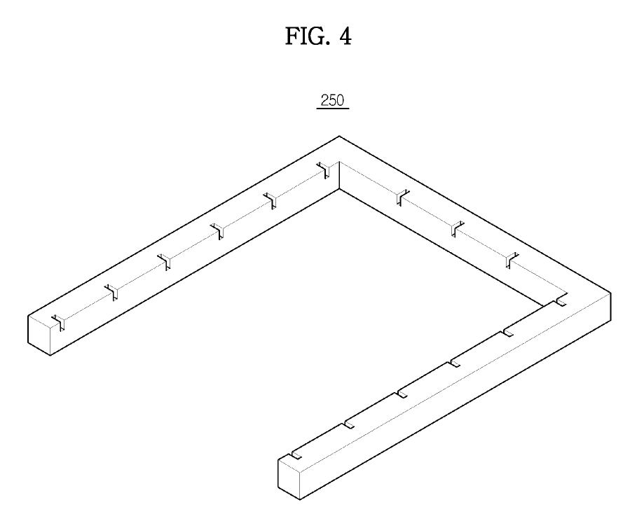

FIG. 4 is a perspective view illustrating another example embodiment of the lifting unit.

In the previous example embodiment, the support parts 220 of the lifting unit 200 are disposed at the opposite sides of the supporting unit 100 to support the tray 300.

To manufacture a large substrate 20, the size of the tray 300 is increased, and the weight of the substrate 20 and the tray 300 increases.

When a support part 250 is integrally formed in a bracket shape as shown in FIG. 4, the large substrate 20 and the tray 300 to support the substrate 20 are stably supported.

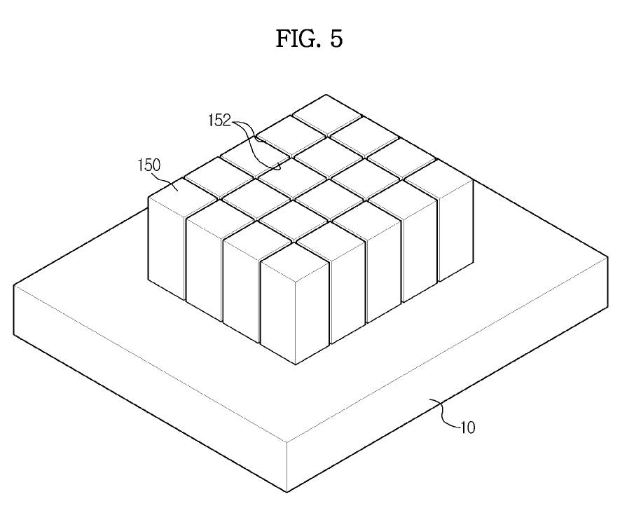

FIG. 5 is a perspective view illustrating another example embodiment of the supporting unit.

As shown in FIG. 5, a plurality of sub-supporting units 150 is provided.

The sub-supporting units 150 are disposed at predetermined/desired intervals to form through channels 152 therebetween.

The through channels 152 formed between the sub-supporting units 150 correspond to the frames 310 such that the tray 300 is moved upward and downward through the through channels 152.

The shape and disposition of the sub-supporting units 150 may be changed based on the shape of the lattices constituted by the frames 310.

In an example embodiment, the sub-supporting units 150 may be selectively replaced, for example, after being damaged during a substrate processing operation.

Hereinafter, a method of loading and unloading the substrate 20 using the substrate processing apparatus 1 will be described with reference to the accompanying drawings.

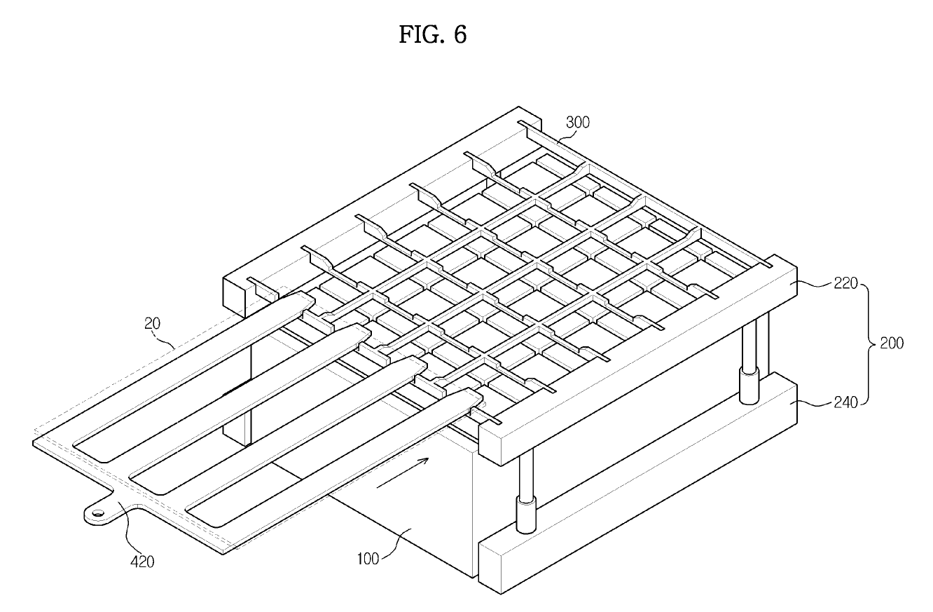

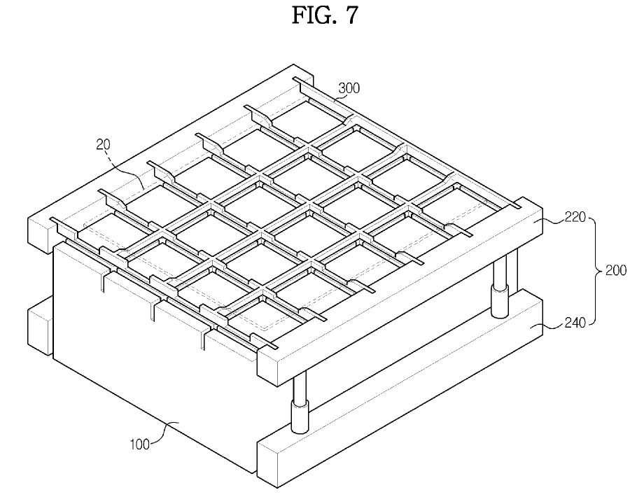

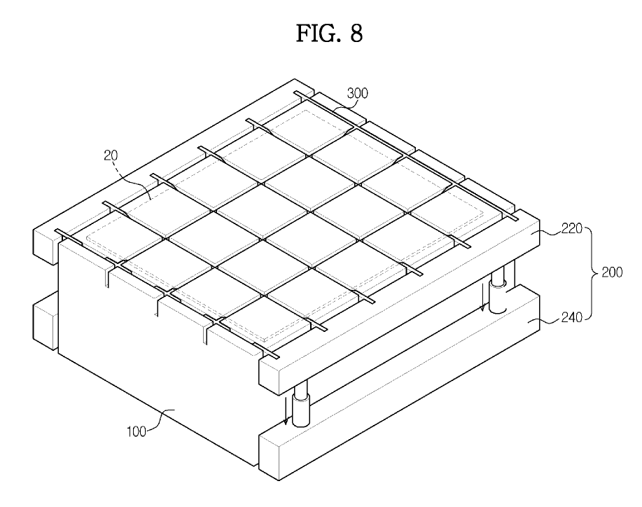

FIG. 6 is a perspective view illustrating a state in which the substrate is transferred on the tray by a transfer part of the transfer unit, FIG. 7 is a perspective view illustrating a state in which the substrate is positioned on the tray, and FIG. 8 is a perspective view illustrating a state in which the lifting unit and the tray are moved downward to position the substrate on the support.

As shown in FIGS. 6 to 8, the tray 300 is moved upward until the bottom of the tray 300 is higher than the top of the supporting unit 100 in a state in which the tray 300 is coupled in the support grooves 222 provided at the support parts 220 of the lifting unit 200.

When the tray 300 is moved upward to a predetermined/desired position, the transfer part 420 of the transfer unit 400 enters the tray 300 in a state in which the substrate 20 is fixed by suctioning.

At this time, the transfer part 420 enters the tray 300 through the avoidance grooves 320 provided at the frames 310, and therefore, the transfer part 420 does not contact the tray 300.

The substrate 20 is positioned slightly higher than the substrate support surfaces 360 of the tray 300, and therefore, the substrate 20 does not interfere with the tray 300 while the substrate 20 is transferred on the tray 300 together with the transfer part 420.

When the substrate 20 is placed at a predetermined/desired position after being transferred by the transfer part 420, the transfer part 420 positions the suctioned substrate 20 on the substrate support surfaces 360 of the tray 300.

When the substrate 20 is positioned on the substrate support surfaces 360, the transfer part 420 is moved out of the tray 330 through the avoidance grooves 320 provided at the frames 310.

When transfer of the substrate 20 to the substrate support surfaces 360 of the tray 300 and alignment of the substrate 20 on the substrate support surfaces 360 of the tray 300 are completed, the vertical transfer parts 240 included in the lifting unit 200 is operated to simultaneously move the support parts 220, the tray 300 and the substrate 20 downward.

When the support parts 220 are moved downward, the tray 300 supported by the support parts 220 is simultaneously moved downward along the through grooves 112 provided at the supporting unit 100 until the substrate support surfaces 360 are lower than the substrate location surface 114 of the supporting unit 100.

When the substrate support surfaces 360 are placed at the same level as the substrate location surface 114 during the downward movement of the tray 300, the substrate 20 positioned on the tray 300 is separated from the tray 300, and, at the same time, is loaded on the substrate location surface 114 of the supporting unit 100.

When the substrate processing apparatus 1 with the above-stated construction is used, the tray 300 and the lifting unit 200 to move the tray 300 are disposed around the supporting unit 100 such that the tray 300 and the lifting unit 200 are moved downward and upward to load and unload the substrate 20 on and from the supporting unit 100. Consequently, damage to the substrate 20 may be reduced, and an amount of particles generated during loading of the substrate 20 on the supporting unit 100 is reduced.

When the loading is completed, the substrate 20 is brought into tight contact with the substrate location surface 114 by a substrate fixing unit (not shown) provided at the supporting unit 100, and then the substrate 20 is processed.

When the processing of the substrate 20 is completed, the fixing of the substrate by the substrate fixing unit is released such that the substrate 20 is separated from the substrate location surface 114. The vertical transfer parts 240 of the lifting unit 200 are operated to simultaneously move the support parts 220, the tray 300 and the substrate 20.

When the substrate support surfaces 360 are placed at the same level as the substrate location surface 114 during the upward movement of the tray 300, the substrate 20 positioned on the substrate location surface 114 is supported by the tray 300, and, at the same time, is unloaded from the substrate location surface 114 of the supporting unit 100.

The tray 300 is moved upward to a state in which the substrate 20 is supported by the tray 300 until the bottom of the tray 300 is higher than the top of the supporting unit 100.

When the tray 300 is stopped, the transfer part 420 enters the tray 300 through the avoidance grooves 320 provided at the frames 310 to separate the substrate from the substrate support surfaces 360 of the tray 300.

The transfer part 420 fixes the separated substrate 20 by, for example, suctioning and then transfers the substrate 20 out of the tray 300.

As is apparent from the above description, damage to the substrate is minimized when the substrate is loaded on or unloaded from the support.

Since the substrate is not damaged, a product defect rate is lowered, thereby improving productivity.

Also, an amount of particles generated when the substrate is loaded on the support is reduced.

Also, the substrate is positioned on the support using the simple substrate transfer structure and with relative high accuracy.

Also, the components to transfer the substrate are disposed around the support, thereby facilitating a relatively easy arrangement of components.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A substrate processing apparatus comprising:
a supporting unit;
a lifting unit on at least a side of the supporting unit;
a tray supported by the lifting unit; and
a transfer unit configured to transfer a substrate to the tray such that the substrate is positioned on the tray, wherein
the lifting unit is configured to move the tray up and down to load or unload the substrate positioned on the tray.

2. The substrate processing apparatus according to claim 1, wherein the lifting unit comprises support parts configured to support the tray and vertical transfer parts configured to move the tray and the substrate up and down.

3. The substrate processing apparatus according to claim 2, wherein each support part includes a plurality of support grooves configured to supportingly engage the tray.

4. The substrate processing apparatus according to claim 3, wherein the tray comprises a plurality of frames, and the frames form lattices.

5. The substrate processing apparatus according to claim 4, wherein each frame comprises avoidance grooves configured to avoid interference between the plurality of frames and a transfer part of the transfer unit.

6. The substrate processing apparatus according to claim 5, wherein each frame further comprises incline parts configured to position the substrate.

7. The substrate processing apparatus according to claim 4, wherein the supporting unit includes through grooves at positions corresponding to the frames, the tray being lowered into the supporting unit via the through grooves.

8. The substrate processing apparatus according to claim 4, wherein the supporting unit includes a plurality of sub-supporting units, and the plurality of sub-supporting units include through channels therebetween at positions corresponding to the frames, the tray being lowered into the supporting unit via the through channels.

9. A substrate transferring method comprising:
disposing a tray supported by a lifting unit, the lifting unit being on at least a side of a supporting unit;
positioning a substrate on the tray using a transferring unit; and
moving the tray up and down using the lifting unit to load or unload the substrate positioned on the tray.

10. The substrate transferring method according to claim 9, wherein moving the tray up and down using the lifting unit comprises:
supporting the tray using support parts of the lifting unit, and
moving the tray and the substrate up and down using vertical transfer parts of the lifting unit.

11. The substrate transferring method according to claim 10, further comprising:
providing each support part with support grooves configured to supportingly engage the tray.

12. The substrate transferring method according to claim 11, further comprising:
providing the tray including a plurality of frames, and the plurality of frames form lattices.

13. The substrate transferring method according to claim 12, further comprising:
providing avoidance grooves configured to avoid interference between the frames and a transfer part of the transfer unit on each frame.

14. The substrate transferring method according to claim 13, further comprising:
providing each frame with incline parts configured to position the substrate.

15. The substrate transferring method according to claim 12, further comprising:
providing the supporting unit with through grooves at positions corresponding to the frames, and
lowering the tray into the supporting unit via the through grooves.

16. The substrate transferring method according to claim 12, further comprising:
providing the supporting unit with a plurality of sub-supporting units, the plurality of sub-supporting units including through channels therebetween at positions corresponding to the frames, and
lowering the tray into the supporting unit via the through channels.

17. The substrate transferring method according to claim 15, wherein moving the tray comprises:
moving the support parts and the tray supported by the support parts downward, the tray being moved along the through grooves of the supporting unit, and
separating the substrate from the tray and simultaneously loading the substrate on the supporting unit.

18. The substrate transferring method according to claim 17, wherein moving the tray comprises:
moving the support parts and the tray supported by the support parts upward, the tray being moved along the through grooves of the supporting unit, and
positioning the substrate on the tray and simultaneously unloading the substrate from the support.

19. The substrate transferring method according to claim 16, wherein moving the tray comprises:
moving the support parts and the tray supported by the support parts downward, the tray being moved along the through channels, and
separating the substrate positioned on the tray and simultaneously loading the substrate on the supporting unit.

20. The substrate transferring method according to claim 19, wherein moving the tray comprises:
moving the support parts and the tray supported by the support parts upward, the tray being moved along the through channels, and
positioning the substrate on the tray and simultaneously unloading the substrate from the support.
